(19) United States
(12) Patent Application Publication
(10) Pub. No.: US 2021/0056607 A1
(43) Pub. Date: Feb. 25, 2021

(54) SYSTEM AND METHOD FOR RECOMMENDING PROPERTIES TO USERS FOR ESTABLISHING RELATIONSHIP BETWEEN USERS

(71) Applicant: Carrier Corporation, Palm Beach Gardens, FL (US)

(72) Inventor: Hrishi Eathakota, Hyderabad (IN)

(21) Appl. No.: 16/991,273

(22) Filed: Aug. 12, 2020

(30) Foreign Application Priority Data
Aug. 23, 2019 (IN) 201911034054

(51) Int. Cl. G06Q 30/06; G06Q 30/02; G06Q 50/16; G06F 16/908; G06F 16/9032; G06F 16/9035; G06T 7/00

(52) U.S. Cl. CPC G06Q 30/0627; G06Q 30/0631; G06Q 30/0282; G06T 7/0002; G06F 16/908; G06F 16/90324; G06F 16/9035; G06Q 50/163

(57) ABSTRACT

Aspects of the invention are directed towards a method and a system for recommending properties to a user based on image analysis and thereby, establish relationship between different users of the property. One or more embodiments of the invention describe the methods comprising steps of receiving an image of a property from a user and determining one or more attributes associated with the image. Based on the received image and the attributes of the image, one or more queries are prompted to the user. The method further comprises the steps of receiving information corresponding to the one or more queries from the user and determining at least one suitable property based on the information provided by the user and the one or more attributes associated with the image.

### FOREIGN PRIORITY

This application claims priority to Indian Patent Application No. 201911034054, filed Aug. 23, 2019, and all the benefits accruing therefrom under 35 U.S.C. § 119, the contents of which in its entirety are herein incorporated by reference.

### TECHNICAL FIELD OF INVENTION

The present invention relates generally to image processing. More particularly, the invention relates to a system and a method for recommending properties to a user based on an analysis of an image.

### BACKGROUND OF THE INVENTION

Buying a property is generally considered to be one of the life's big buys or rather a milestone and is an important event for a buyer. It is an experience associated with the entire process of seeing, visiting, choosing and finally buying a property. Every buyer wants that the entire course of events to be as smooth as possible. In reality, buying a property can be a tedious and cumbersome process.

The general practice followed by the buyer when desirous of buying a property is to first find a trustworthy real estate agent and then discuss preferences as well as requirements pertaining to a property. The buyer has to put his/her efforts to make the real estate agent understand what's in the buyer's mind regarding his/her prospective property. Based on the buyer's preferences as well as requirements, the agent suggests properties to the buyer which are viewed by the buyer. Then, the buyer chooses/selects a suitable property and finally buys the property. Out of all the steps mentioned above, the most important and the most critical step is where the buyer has to try and make the agent visualize his/her prospective property through his/her words and description. It is because the properties that the agent ultimately shows to the buyer depends on the agent's comprehension of the buyer's requirements and preferences. This is what that can make pleasant or ruin one's property buying experience because if the agent is not able to properly fathom the buyer's interest, the properties that the agent will show to the buyer will not be of any interest to the buyer. This will not only lead to a wastage of time but may also lead to frustration and inconvenience.

Therefore, the need of exact communication of the buyer's interest to the agent cannot be undermined. However, many times it happens that the buyer's interest in a property is triggered by looking at some existing properties or may be pictures of some property. In such cases, it is possible that the buyer may not be able to exactly put in words what the buyer likes about the particular property. The buyer may like the ambience or just the feel of the place, the surrounding environment, peace, greenery etc. or anything that may not be possible to describe aptly in words. The inability of the buyer to express his/her thoughts to the agent may consequently lead to a bitter and unpleasant property buying experience for the buyer and may be loss of business for the real estate agent.

In recent times, the buyer can now browse through the various real estate websites or use various property based applications to search for a suitable property. However, this approach too has its limitations. One of the major disadvantages is that all the information that is provided on these websites is more from a seller's perspective and less from a buyer's perspective. Only limited information regarding the property is shared that may or may not be of interest to the buyer. Further, only selected pictures of the property are shared which are in-adequate convey exactly to the buyer what the property has to offer to the buyer. Sometimes, the pictures displayed on the websites may not exactly match with the property. All this again proves to be a hindrance for the buyer in finding a property of interest.

In view of the aforementioned problems, there is a need of an efficient method and a system to make buying and selling property a pleasant experience for both the buyer as well as the agent. There is also a requirement of helping the real estate agents to serve the buyers better by showing them the properties that exactly match their interests. Thus, there is a need to enable effective communication of buyer's interests pertaining to a property to the agent. Further, a method and a system is also required to easily find a potential real estate agent for one's needs. In order to solve these problems, a system and method is disclosed.

### SUMMARY OF THE INVENTION

Various embodiments of the invention describe a system and a method for recommending properties to a user based on an analysis of an image provided by the user and thereby establish a relationship between different users of the property. The invention discloses a method comprising steps of receiving an image of a property from a user and determining one or more attributes associated with the image. Based on the received image and the attributes of the image, one or more queries are prompted to the user. The method further comprises receiving information corresponding to the one or more queries from the user and determining at least one suitable property based on the information provided by the user and the one or more attributes associated with the image.

In another embodiment of the invention, the one or more attributes associated with the image comprise a colour, a height, a number of levels, a location and/or a structure of the property.

In another embodiment of the invention, each of the one or more attributes associated with the image is assigned a probability for determining a suitable property.

In yet another embodiment of the invention, the one or more queries prompted to the user are based on the one or more attributes associated with the image.

In still another embodiment of the invention, the information corresponding to the one or more queries indicates interest of the user in a property.

In an embodiment, a suitable property is determined by filtering from a list of properties stored in a server.

In another embodiment, the user is associated with a user application to determine a suitable property.

In a different embodiment, a suitable property is recommended to the user for establishing a relationship between different users of the property

In another different embodiment, the different users are a buyer and an agent of a property, wherein the agent of a property is notified by the server for recommendation of a suitable property to the buyer.

In yet another different embodiment, the user provides rating to the recommended suitable property.

In yet another embodiment of the invention, a system is disclosed for recommending properties to a user based on analysis of an image provided by the user and establishing a relationship between different users of the property. The system comprises of an electronic device of the user comprising of a camera adapted to capture an image of the property and a communication unit adapted to transmit the image of the property to a server. The system also comprises of a server comprising a communication module adapted to receive the image of the property from the electronic device and an analysis module adapted to determine one or more attributes associated with the image and prompt one or more queries to the user based on the received image and the one or more attributes of the image. The communication module is further adapted to receive information corresponding to the one or more queries from the user and the analysis module is further adapted to determine at least one suitable property based on the information provided by the user and the one or more attributes associated with the image.

In another embodiment of the invention, the server determines a total number of users viewing a suitable property and/or interested in a suitable property.

In yet another embodiment of the invention, the one or more attributes associated with the image comprise a color, a height, a number of levels, a location, and/or a structure of the property.

In still another embodiment of the invention, each of the one or more attributes associated with the image is assigned a probability for determining a suitable property.

In another embodiment of the invention, the one or more queries prompted to the user are based on the one or more attributes associated with the image.

In an embodiment, the information corresponding to the one or more queries indicates the interest of the user in a property.

In another different embodiment, a suitable property is determined by filtering a list of properties stored in the server.

In yet another embodiment, the user is associated with a user application to determine a suitable property.

In various other embodiments of the invention, a computer readable medium is disclosed comprising one or more processors and a memory coupled to the one or more processors. The memory stores instructions which are executed by the one or more processors to receive an image of a property from a user and determine one or more attributes associated with the image. The memory stores instructions which are executed by the one or more processors configured to prompt one or more queries to the user based on the image received and its attributes. The memory also stores instructions which are executed by the one or more processors configured to receive information (reply/response) from the user corresponding to the one or more queries raised and determine at least one suitable property based on the information provided by the user and the one or more attributes associated with the image.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is an exemplary diagram illustrating a system in accordance with an exemplary embodiment of the invention.

FIG. 2 is an exemplary block diagram of different components of the electronic device of the user according to an exemplary embodiment of the invention.

FIG. 3 is an exemplary block diagram of different components of the server according to an exemplary embodiment of the invention.

FIG. 4 is an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with a system and method for recommending properties to a user based on an analysis of an image provided by the user and thereby establish a relationship between different users of the property. The user using an electronic device may capture the image of the property. The electronic device then transmits the image of the property to a server. The server then analyses one or more attributes of the image based on which one or more queries are prompted to the user to understand user preferences. After receiving the required information from the user, the matching properties are identified and recommended to the user. The server communicates with the user device over a cellular network or a Wi-Fi network.

As used herein, the user may be, but not limited to, a buyer user, an agent user, a property owner user or any other such user known in the art.

As used herein, the property may include, but is not limited to, a plot, a house, a villa, a bungalow, a cottage, a lodge, a mansion, a townhouse, a rowhouse, a building, an apartment, a condominium, a complex, an office space, a shop, a showroom, an outlet or any such property well known in the art.

As used herein, the electronic device may refer to any device that is capable of capturing the image and transmitting it to the server. Such an electronic device may include, a processor, a memory, a display, an input means, a camera, a communication unit, and any such component known in the art. The electronic device may communicate with the server using a cellular network or a Wi-Fi network. Such electronic device may be either a mobile phone, a smartphone, a tablet or a wearable device, a personal digital assistance (PDA), or any such device known in the art.

As used herein, the server has processing capabilities as disclosed further in the specification. The server communicates with the user electronic device. The server may be connected with a network to communicate with the electronic device. There may be a cloud storage, a remote database, or any such storage known in the art.

As used herein, the one or more attributes associated with the image which are analyzed by the server may include, but not limited to, color, height, number of levels/floors, number of doors or windows, location, structure of the property (for instance, the layout or design or shape of the property), construction material used, landscape, ambience, and the like.

As used herein, the one or more queries may be based on the image attributes, the image received by the user and/or user preferences. The queries may include, but are not limited to, questions pertaining to the image and the image attributes such as color, height, design, outer appearance and/or number of floors, doors and/or windows. The queries may also pertain to the user preferences including, but not limited to, proximity to schools, colleges or hospitals; nearby malls, eating joints, restaurants, library, gym, shopping complex, metro, bus stands; presence/absence of parks or playgrounds; locality; preferred floor; swimming pool; car parking; terrace or/and number of balconies.

As used herein, the cellular network may refer to a Global System for Mobile (GSM) network, Long-Term Evolution (LTE) network, a code-division multiple access (CDMA) network or any such network that is known in the art.

As used herein, the Wi-Fi network may refer to a network based on IEEE 802.11 Standards and provided by a Wi-Fi access point. Such network provides coverage within a specified limit.

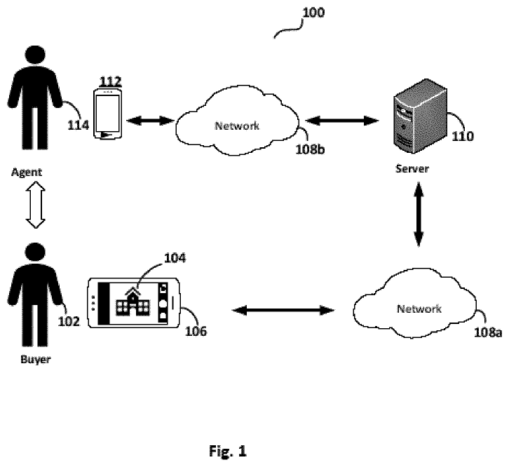

FIG. 1 depicts an exemplary system architecture 100 for recommending properties to the user and establish relationship between different users, user 102 and user 114, of the property, in accordance with an exemplary embodiment of the invention. As depicted in FIG. 1, the system architecture 100 comprises of two users. Considering an example, user 102 may be a buyer and user 114 may be an agent. The user electronic device 106 and the electronic device 112, wherein the user device 106 belongs to the user 102 and the electronic device 112 belongs to the user 114 may be communicably connected to the server 110 through the network 108a and the network 108b, respectively. As can be seen in FIG. 1, the electronic device 106 of the user 102 is showing the image 104 of the property.

When the user 102 is desirous of buying a property, the user 102 may view a property and like it. The user 102, through an application, may be able to point a camera of the electronic device 106 at the property of interest and may capture an image 104 of the property using the camera of the electronic device 106. Alternatively, the user 102 may select an image 104 of the property from a web portal or any other means. The electronic device 106 may transmit the image 104 of the property to the server 110 through the network 108a. The user 102 may also submit his/her preferences such as proximity to a school, presence of a terrace garden and the like on being prompted with one or more queries by the server 110. In an exemplary embodiment, the server 110 may prompt queries in the form of questionnaire such as, “Do you want the property to be near a shopping complex?” and/or “Do you want a terrace or private garden?” and/or “How many floors must be there in the property?” and/or “Do you want an east facing property?” and/or “Do you want a corner plot?” and so on and so forth. The server 110 may then employ artificial intelligence engine and machine learning technologies to analyse the image 104 and determine the attributes of the image 104 provided by the user 102. The feature of determining attributes of the image 104 has been explained below.

Based on the image 104 received by the server 110 and the attributes determined by the artificial intelligence engine of the server 110, the server 110 may then prompt another set of one or more queries to the user 102 pertaining to attributes of the image 104 of the property. In an exemplary embodiment, the server 110 may prompt queries such as, “Do you want the property to have arched windows?” and/or Do you want the property to be white in colour?” and/or “Do you like awning windows?” and/or “Do you want the property to have glass doors?” and/or “Do you wish to have bricked walls in the property?” and/or “Do you want to have a front lawn in the property?” and so on and so forth.

The server 110 may communicate the queries through the network 108a to the electronic device 106 of the user 102. The user 102 may then provide information corresponding to the queries. Such information/answers corresponding to the queries related to attributes of the image 104 and the user preferences are transmitted by the electronic device 106 to the server 110 through the network 108a. The server 110 may then analyse the information/answers provided by the user 102 using the artificial intelligence engine to determine at least one suitable matching property. The artificial intelligence engine may use the attributes of the image 104 and the information/answers corresponding to the queries to filter out irrelevant properties and shortlist one or more properties that are likely to be of interest to the user 102. The selected matching properties may be recommended to both the user 102 and the user 114 by the server 110 through the networks 108a and 108b. The details of the relevant property may be shared with both the user 102 and user 114 which may be viewed in the application using the electronic device 106 and the electronic device 112. The present invention, therefore, connects potential buyers and agents thereby establishing a buyer-agent relationship.

Although as depicted in the FIG. 1, the user 102 and the user 114 communicate with the server 110 by using different networks 108a and 108b; however, it is also appreciated by a person skilled in the art that the user 102 and the user 114 may communicate with each other using the same network.

The attributes of the image 104 of the property are determined by the server 110 by employing artificial intelligence and machine learning methodologies. The server 110 may have an artificial intelligence engine equipped to learn new heuristics. The artificial engine may determine the attributes of the image 104 of the property by running an algorithm. The self learning algorithm may be first trained by processing a large amount of data and recognizing patterns in data that enables the algorithm to identify the image 104 attributes.

The present invention also encompasses the server 110 to utilize a propensity model for recommending the suitable property to the user 102. The image 104 of the property may be first analysed to determine various attributes of the image 104 of the property. Each of the attributes of the image 104 of the property may be assigned a probability by the propensity model using the artificial intelligence engine. The probability value may be assigned to the attributes of the image 104 of the property by matching with the attributes of the existing properties on the server 110. Each of the property in the server 110 may then be allotted a score. A threshold value of the score may be predefined to filter out only those properties that are assigned a score value above the predefined threshold value. Based on the scores assigned by the propensity model developed, potential properties that may be of interest to the user 102 may be predicted.

For example, the user 102 may upload the image of the property having attributes such as one door, four windows, zero balcony, two floors, no garden, a car parking and red walls, to the server 110. The propensity model may then determine the various attributes of the image 104 and assign each of the attributes a probability value, by comparing the attributes of the image 104 with those of the existing properties in the server 110, using the artificial intelligence engine. Accordingly, a door may be assigned 95% probability value, windows may be given 90% probability value, balcony may be allotted a probability value of 10%, number of floors may be allocated 80% probability, garden may be assigned 5% probability value, car parking may be given a value of 95% probability value, the red walls may be assigned a value of 60% and so on and so forth. Each of the existing property in the database may be then allocated a score, say from 1 to 10. For instance, there may be 1000 properties in the server 110. Out of 1000 properties, 10 properties may be assigned a score between 8 to 9, 7 being the threshold value of the score. Accordingly, the 10 suitable matching properties having score value above the predefined threshold value may be retrieved by the propensity model from the server 110 of properties and may be recommended to the user 102 and/or user 114.

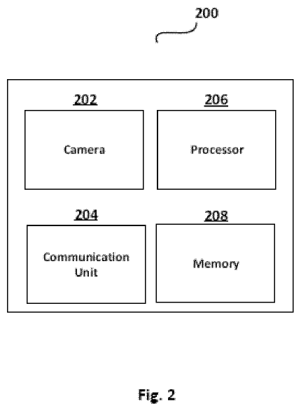

FIG. 2 depicts the exemplary block diagram of different components of the electronic device 106/112 of the user 102/114, according to an embodiment of the invention. The electronic device 106/112 of the user 102/114 comprises, but is not limited to, a camera 202, a communication unit 204, a processor 206 and a memory 208. The camera 202 may be adapted to capture the image 104 of the property. The camera 202 may further be adapted to show real time information about the property such as, location of the property, area of the property, number of floors, number of rooms and the like in the application. The communication unit 204 may be adapted to transmit the image 104 of the property to the server 110 through the network 108. The communication unit 204 may also be adapted to receive one or more queries based on the image 104 and the one or more attributes of the image 104 from the server 110. The communication unit 204 may further be adapted to transmit information corresponding to the queries to the server 110 and receive recommendations of a suitable property from the server 110 as explained above in FIG. 1.

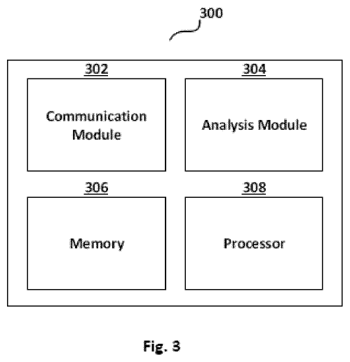

FIG. 3 depicts the exemplary block diagram of different components of the server 110, according to an exemplary embodiment of the invention. The server 110 comprises, but is not limited to, a communication module 302, an analysis module 304, a memory 306 and a processor 308 which work together to achieve the different functions that are performed by the server 110. The communication module 302 may be adapted to receive the image 104 of the property uploaded by the user 102. The analysis module 304 may be adapted to analyse the image 104 of the property uploaded by the user 102 to determine one or more attributes of the image 104. Based on the image received and the attributes analyzed, the analysis module 304 may further be adapted to prompt one or more queries to the user 102. The analysis module 304 may also be adapted to analyses the information provided by the user 102 to identify properties matching to the buyer's interest. The shortlisted properties may be then communicated to the user 102 and the user 114 by the communication module 302 to generate home buying leads and thereby establish a relationship between different users 102/114 of the property.

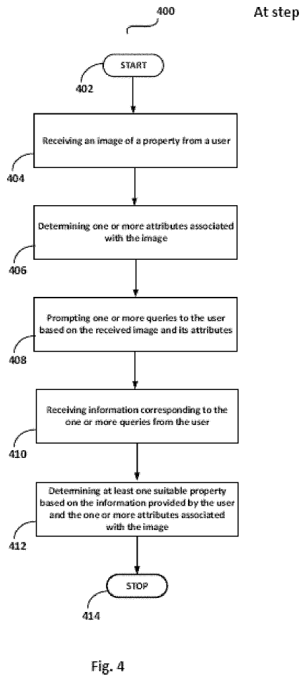

FIG. 4 depicts a flowchart illustrating a method to perform the invention according to an exemplary embodiment of the invention. The method flowchart 400 describes a method being performed for enabling the invention. The method flowchart 400 may start at step 402.

At step 404, the server 110 may receive the image 104 of a property from an electronic device 106 associated with the user 102 through the network 108.

At step 406, the server 110 may employ an artificial intelligence engine of the server to determine one or more attributes associated with the image 104 of the property provided by the user 102

At step 408, the server 110 may prompt one or more queries to the user 102 based on the analysis, of the image 104 of the property and the attributes of the said image of the property 104, carried out by the artificial intelligence engine.

At step 410, the server 110 may receive information corresponding to the one or more queries from the user 102.

At step 412, the server 110 may determine at least one property based on the information provided by the user and the one or more attributes associated with the image 104 of the property using artificial intelligence and machine learning methodologies by employing the artificial intelligence engine of the server. The matching properties may be provided to the users 102, 114 by the server 110 after shortlisting relevant properties from the database of available properties. The method flowchart may end at step 414.

Although the present invention is applicable to the real estate industry and has been described to recommend a suitable property to a user and to establish a relationship between different users of the property; however, it is well understood for a person skilled in the art that the present invention can be used in any scenario where anything other than the property may be recommended to the user based on an analysis of an attribute of an image and the information provided by the user.

The present invention provides the following technical advantages over the existing solutions of property buying where the buyer user faces various hardships in finding a suitable property of interest: a) makes the property buying experience better by eliminating the need to search for an appropriate real estate agent, b) shows only those properties that are of interest to the buyer user thereby saving time and effort, c) makes use of artificial intelligence and machine learning methodologies to understand buyer user's preferences and provide matching properties, d) eases the process of articulating a home description by enabling the buyer user to use an application instead of vocal and written communication, e) helps the buyer user convey his likes/dislikes and preferences by answering queries pertaining to a property to the agent user even in situations when the buyer user is unable to express in words what he/she likes about a property, f) generates home buying leads from buyer users, g) connects potential buyer users and agent users, h) helps the real estate agents to serve the buyer users better by showing them the properties that exactly match their interests, and I) helps establish a relationship between different users (buyer user-agent user) of the property.

The embodiments of the invention and the tables discussed herein are exemplary and various modification and alterations to a person skilled in the art are within the scope of the invention.

In one embodiment of the invention, the invention can be operated using the one or more computer readable devices. The one or more computer readable devices can be associated with the server 110. A computer readable medium comprises one or more processors and a memory coupled to the one or more processors, the memory storing instructions executed by the one or more processors, the one or more processors configured to receive the image 104 of the property by the user 102. The memory storing instructions which are executed by the one or more processors configured to determine one or more attributes associated with the image 104 of the property and prompt one or more queries to the user 102 based on the image received and the attributes of the image 104. The memory storing instructions which are executed by the one or more processors are further configured to receive information corresponding to one or more queries associated with the image 104 of the property from the user 102 and determine at least one suitable property based on the information provided by the user 102 and the one or more attributes associated with the image 104 of the property that is then recommended to the user 102/114.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving an image of a property from a user;
determining one or more attributes associated with the image;
prompting one or more queries to the user based on the received image and the attributes of the image;
receiving information corresponding to the one or more queries from the user; and
determining at least one suitable property based on the information provided by the user and the one or more attributes associated with the image.

2. The method of claim 1, wherein the one or more attributes associated with the image include color, a height, a number of levels, a location, and/or a structure of the property.

3. The method of claim 1, wherein each of the one or more attributes associated with the image is assigned a probability for determining the suitable property.

4. The method of claim 1, wherein the one or more queries prompted to the user are based on the one or more attributes associated with the image.

5. The method of claim 1, wherein the information corresponding to the one or more queries indicate interest of the user in the property.

6. The method of claim 1, wherein the suitable property is determined by filtering from a list of properties stored in a server.

7. The method of claim 1, wherein the user is associated with a user application to determine the suitable property.

8. The method of claim 1, wherein the suitable property is recommended to the user for establishing a relationship between different users of the property.

9. The method of claim 8, wherein the different users are a buyer and an agent of the property, wherein the agent of the property is notified by the server for recommendation of the suitable property to the buyer.

10. The method of claim 9, wherein the user provides rating to the recommended suitable property.

11. A system comprising:
an electronic device of a user including:
a camera adapted to capture an image of a property; and
a communication unit adapted to transmit the image of the property to a server; and
the server including:
a communication module adapted to receive the image of the property from the electronic device;
an analysis module adapted to:
determine one or more attributes associated with the image;
prompt one or more queries to the user based on the received image and the one or more attributes of the image;
the communication module further adapted to receive information corresponding to the one or more queries from the user; and
the analysis module further adapted to determine at least one suitable property based on the information provided by the user and the one or more attributes associated with the image.

12. The system of claim 11, wherein the server determines a total number of users viewing the suitable property and/or interested in the suitable property.

13. The system of claim 11, wherein the one or more attributes associated with the image include color, a height, a number of levels, a location, and/or a structure of the property.

14. The system of claim 11, wherein each of the one or more attributes associated with the image is assigned a probability for determining the suitable property.

15. The system of claim 11, wherein the one or more queries prompted to the user are based on the one or more attributes associated with the image.

16. The system of claim 11, wherein the information corresponding to the one or more queries indicates interest of the user in the property.

17. The system of claim 11, wherein the suitable property is determined by filtering a list of properties stored in the server.

18. The system of claim 11, wherein the user is associated with a user application to determine the suitable property.

19. The system of claim 11, wherein the suitable property is recommended to the user for establishing a relationship between different users of the property.

20. A computer readable medium comprising one or more processors and a memory coupled to the one or more processors, the memory storing instructions which are executed by the one or more processors, the one or more processors configured to:
receive an image of a property from a user;
determine one or more attributes associated with the image;
prompt one or more queries to the user based on the received image and the attributes of the image;
receive information corresponding to the one or more queries from the user; and
determine at least one suitable property based on the information provided by the user and the one or more attributes associated with the image.
